(19) United States
(12) Patent Application Publication
(10) Pub. No.: US 2021/0234590 A1
(43) Pub. Date: Jul. 29, 2021

(54) BEAM STEERING BASED ON OUT-OF-BAND DATA TRACKING

(71) Applicant: HEWLETT-PACKARD DEVELOPMENT COMPANY, L.P., Spring, TX (US)

(72) Inventors: Richard Sweet, San Diego, CA (US); Sunil Bharitkar, Palo Alto, CA (US); Madhu Sudan Athreya, Palo Alto, CA (US)

(21) Appl. No.: 16/606,255

(22) PCT Filed: Feb. 15, 2018
(86) PCT No.: PCT/US18/18400

§ 371 Date: Oct. 18, 2019

(51) Int. Cl. H04B 7/06; H04W 4/02; G01S 5/02; G01S 5/16; G01S 5/18; H04W 16/28

(52) U.S. Cl. CPC H04B 7/0617; H04W 4/025; H04W 16/28; G01S 5/16; G01S 5/18; G01S 5/0284

(57) ABSTRACT

A location of a first wireless device relative to a second wireless device with which the first wireless device exchanges an in-band data stream is determined. The in-band data stream is exchanged via a wireless signal, and the location is determined based at least in part on an out-of-band data stream originating at the first wireless device. A direction toward which to steer a beam of radiation emitted by an antenna array of the first wireless device is determined based on the location. An instruction is then transmitted to the first wireless device. The instruction instructs the first wireless device to steer the beam toward the direction.

### BACKGROUND

Wireless fidelity (WiFi) beam forming is a process by which the focus of a WiFi signal is narrowed (e.g., forming a beam) to improve the strength of the signal at a receiver. For instance, the transmitter and/or the receiver of the WiFi signal may steer the beam emitted by its antenna array by shifting the phase of each antenna in the array by a different amount, so that the signal strength is improved. Or, if the antennas have fixed directions and beam widths, the antennas may be switched to steer the beam in one of a set of available fixed beam patterns.

### BRIEF DESCRIPTION OF THE DRAWINGS

FIG. 1 depicts a high-level block diagram of an example wireless network of the present disclosure;

FIG. 2 is a flow diagram illustrating an example method for beam steering based on tracking of out-of-band data;

FIG. 3 is a flow diagram illustrating an example method for determining the locations of a plurality of wireless client devices operating simultaneously in the same wireless network;

FIG. 4 illustrates an example of an apparatus.

### DETAILED DESCRIPTION

The present disclosure broadly describes an apparatus, method, and non-transitory computer-readable medium for beam steering based on out-of-band data tracking. As discussed above, wireless fidelity (WiFi) beam forming is a process by which the focus of a WiFi signal is narrowed to improve the strength of the signal at a receiver. For instance, the wireless transmitter and/or receiver may steer the beam emitted by its antenna array by shifting the phase of each antenna in the array by a different amount. Or, if the antennas have fixed directions and beam widths, the antennas may be switched to steer the beam in one of a set of available fixed beam patterns. The in-band data sequences produced by the antennas contain data (e.g., declining receive signal strength) from which the optimal direction in which to steer or switch each antenna may be determined.

By transmitting the data used for beam steering in the in-band data sequences, the amount of other data that can be transmitted in the data channel is reduced. This can create a poor user experience in applications where the user and/or host move frequently (such as virtual reality applications or robotics applications), as the antennas will adjust their beams frequently in order to maintain optimal signal strength in light of the user and/or host movement, and the data used to adjust the beams will consume channel bandwidth that could otherwise be used to transmit application data.

Examples of the present disclosure maximize the amount of application data that can be transmitted in a wireless channel (e.g., a millimeter wave channel) by using out-of-band data to steer a wireless antenna array. The out-of-band data may comprise, for example, an audio beacon emitted by a wireless device, an imaging sensor (e.g., camera, three-dimensional depth sensor, or the like) feed tracking movement of a wireless device, an infrared pattern emitted by a wireless device (e.g., in a plurality of infrared signals), the energy emitted by a wireless device (e.g., in a radio frequency or radar signal), or other out-of-band data.

In one example, the out-of-band data is used to dynamically modify the weights associated with individual antennas in the antenna array. For instance, a set of weights for the antennas may be predetermined based on the location of a client device relative to a wireless access point (AP). So once the location is determined, a predetermined set of weights associated with that location may be identified and implemented in the antenna array(s) of the client device and/or the wireless AP to steer the beam(s).

In another example, where the individual antennas in the antenna array are switched antennas having fixed directions and beam widths, the antennas may be switched so that the array steers the beam in one of a set of available fixed beam patterns. The beam pattern (and, hence, the switching patterns for the individual antennas) may be predetermined based on the location of the client device relative to the wireless AP. In a further example, each of the switched antennas may have a separate radio element for transmitting and receiving, so that switching of the antennas can be performed in the digital domain at the analytic signal (e.g., I/Q data) feed point rather than at the antenna.

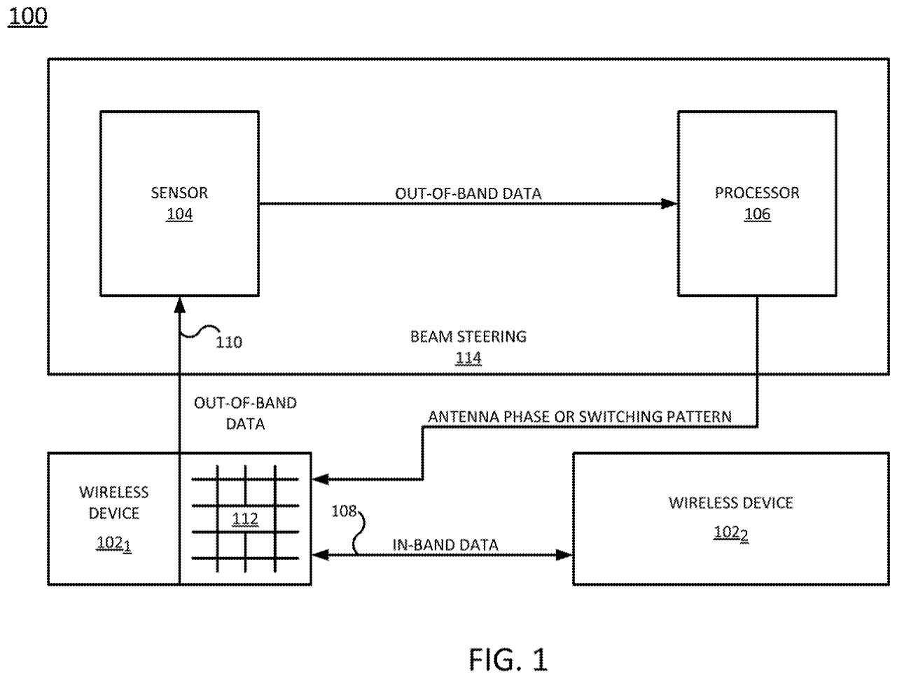

FIG. 1 depicts a high-level block diagram of an example wireless network 100 of the present disclosure. In one example, the wireless network 100 comprises a plurality of wireless devices 102₁-102₂ (hereinafter individually referred to as a “wireless device 102” or collectively referred to as “wireless devices 102”) that communicate with each other to exchange data. For instance, a first wireless device 102₁ and second wireless device 102₂ in the network 100 may exchange in-band data streams over a first data channel 108. The in-band data streams may comprise data related to, for example, an application executing on one or both of the wireless devices 102. For instance, the first wireless device 102₁ may be a movable wireless client device that executes a virtual reality (VR) application (e.g., a head mounted display (HMD) device). The second wireless device 102₂ may be a moveable or fixed-location wireless access point (AP) that provides data to the VR application based on the location of the first wireless device 102₁. In this case, the location of the first wireless device 102₁ relative to the second wireless device 102₂ may change over time, resulting in fluctuations in the signal strength of the first data channel 108.

In one example, the wireless devices 102 may comprise wireless gigabit alliance (WiGig) devices. In a further example, each of the wireless devices 102 includes an antenna array. For instance, as illustrated, the first wireless device 102₁ includes an antenna array 112. Although not illustrated, the second wireless device 102₂ (as well as any other wireless devices 102 in the network 100) may include an antenna array similar to the antenna array 112. In one example, the antenna array 112 comprises a plurality of millimeter wave (mmW) antennas. The phase of each antenna in the antenna array 112 may be independently adjustable so that each antenna may transmit and receive signals at an angle that is different from the angles at which other antennas of the antenna array 112 transmit and receive signals. Alternatively, each antenna may have a fixed direction and beam width, but be independently switched (potentially by a separate radio element). Collectively, the plurality of antennas emits a beam whose direction and amplitude can be steered to optimize the signal strength of the first data channel 108.

In addition, the wireless network 100 comprises a beam steering apparatus 114. The beam steering apparatus 114 provides an overlay in the wireless network 100 that allows the locations of the wireless devices 102 to be tracked using out-of-band data (e.g., data that is not exchanged via the first data channel 108 or via a similar data channel established between other wireless devices 102). The overlay also allows instructions to be sent to the wireless devices 102 to steer the beams emitted by their respective antenna arrays for optimal signal strength, based on their locations.

In one example, the beam steering apparatus 114 generally comprises a sensor 104 and a processor 106.

The sensor 104 may comprise any sensor that is capable of detecting an out-of-band data stream carried over a second data channel 110 that is separate from the first data channel 108. For instance, the sensor may comprise an audio sensor (e.g., configured to detect an audio beacon), a camera (e.g., configured to detect movement or a visible beacon), an infrared sensor (e.g., configured to detect a time of flight of a pattern of emitted infrared signals), an energy sensor (e.g., configured to detect emitted energy), or another type of sensor.

The processor 106 may comprise any type of processor, such as a microcontroller, a microprocessor, a central processing unit (CPU) core, an application-specific integrated circuit (ASIC), a field programmable gate array (FPGA), or the like. The processor 106 is programmed to track the locations of the wireless devices 102 (e.g., to determine the (x,y,z) spatial coordinates of the wireless devices 102) based on the out-of-band data stream.

The processor 106 is further programmed to steer the beams produced by the antenna arrays of the wireless devices 102 based on the locations of the wireless devices 102. For instance, the processor 106 may determine one or more phase shifts, e.g., modifications to the angles by which one or more of the antennas of an antenna array exchanges in-band data streams with another antenna array. Alternatively, the processor 106 may determine a switching pattern for the antennas that steers the beam emitted by the antenna array in one of a set of fixed patterns. The processor 106 may then transmit the antenna phases or switching patterns to a wireless device 102 in an instruction. Based on the instruction, the wireless device may adjust the phases or switching patterns of one or more antennas of its antenna array to steer the beam emitted by the antenna array. As discussed in greater detail below, where the beam is steered by phase-shifting the plurality of antennas of an antenna array, the processor 106 may determine the direction toward which to steer a beam (and/or the amplitude of the beam) by identifying a plurality of weights associated with the plurality of antennas. The plurality of weights may be predetermined to provide an optimal signal strength based on the location of a wireless device relative to another wireless device with which it is exchanging in-band data streams.

Although FIG. 1 illustrates two wireless devices 102 being tracked by the beam steering apparatus 114, the beam steering apparatus 114 may be programmed to track and steer the beams of any number of wireless devices. Where the beam steering apparatus 114 tracks multiple wireless devices, the out-of-band data streams transmitted by the multiple wireless devices may be slightly different for each wireless device. For instance, if the out-of-band data comprises audio beacons, each wireless device may emit an audio tone of a different frequency, so that that the different wireless devices can be distinguished from one another by the beam steering apparatus. In this case, x different available frequencies would enable the beam steering apparatus 114 to track up to 2x different wireless devices.

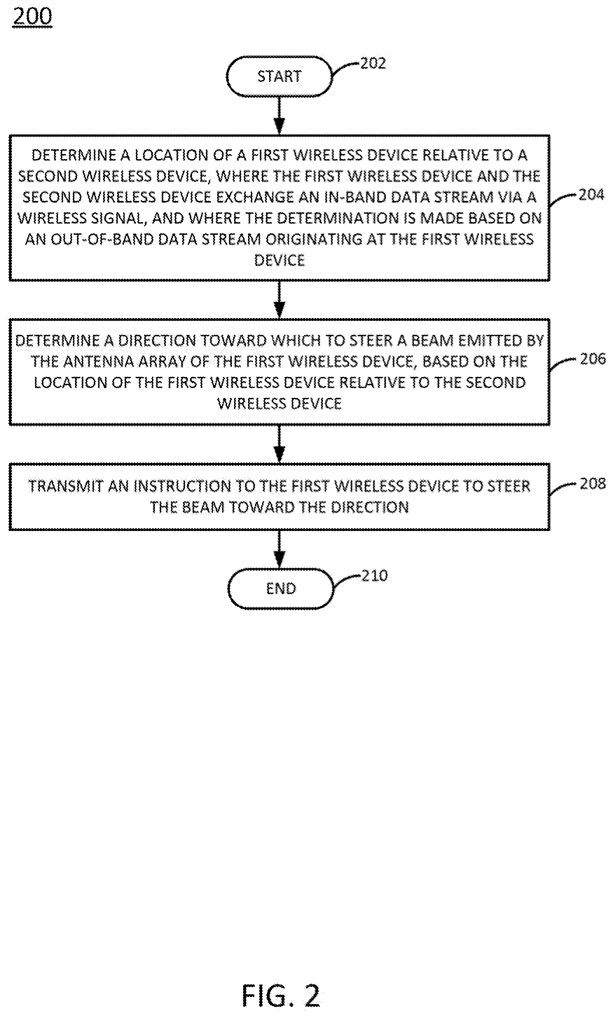

FIG. 2 is a flow diagram illustrating an example method 200 for beam steering based on tracking of out-of-band data. The method 200 may be performed, for instance, by the beam steering apparatus 114 of FIG. 1. As such, reference may be made in the discussion of the method 200 to various components of the wireless network 100. Such references are made for the sake of example, however, and do not limit the means by which the method 200 may be implemented.

The method 200 begins in block 202. In block 204, a location of a first wireless device relative to a second wireless device is determined. In this case, the first wireless device exchanges an in-band data stream with the second wireless device via a wireless signal. For instance, the first wireless device may comprise an HMD, while the second wireless device may comprise a wireless AP. The in-band data stream may carry data related to an application executing on the first wireless device, such as a VR application.

In one example, the location of the first wireless device relative to the second wireless device is determined based at least in part on an out-of-band data stream originating at the first wireless device. The out-of-band data stream is a data stream that is separate from the in-band data stream. Thus, the out-of-band data stream and the in-band data stream may be carried over separate data channels. In one example, the out-of-band data stream comprises an audio beacon emitted by the first wireless device, an imaging sensor (e.g., camera, three-dimensional depth sensor, or the like) feed tracking movement of the first wireless device, a pattern of infrared signals emitted by the first wireless device, the energy emitted by the first wireless device (e.g., in a radio frequency or radar signal), or other out-of-band data.

In block 206, a direction toward which to steer a beam of radiation emitted by an antenna array of the first wireless device is determined, based on the location of the first wireless device relative to the second wireless device. As discussed above, steering the beam toward the direction determined in block 206 may improve a signal strength of the wireless signal over with the in-band data stream is carried.

In one example, the out-of-band data is used in block 206 to dynamically modify the weights associated with individual antennas in the antenna array. For instance, a set of weights for the antennas may be predetermined based on the location of the first wireless device relative to the second wireless device. So once the location is determined, a predetermined set of weights associated with that location may be identified and implemented in the antenna array(s) of the first wireless device to steer the beam.

In another example, where the individual antennas in the antenna array are switched antennas having fixed directions and beam widths, the out-of-band data is used in block 206 to dynamically modify a switching pattern for the antennas that steers the beam in one of a set of available fixed beam patterns. In this case, the beam pattern (and, hence, the switching patterns for the individual antennas) may be predetermined based on the location of the first wireless device relative to the second wireless device. In a further example, each of the switched antennas may have a separate radio element for transmitting and receiving, so that switching of the antennas can be performed in the digital domain at the analytic signal (e.g., I/Q data) feed point rather than at the antenna.

In block 208, an instruction is transmitted to the first wireless device. In one example, the instruction instructs the first wireless device to steer the beam toward the direction determined in block 206. For instance, the instruction may identify specific phase shifts for specific antennas of the first wireless device's antenna array, where implementation of the specific phase shifts will result in the antenna array collectively forming a beam that is steered in the direction determined in block 206. Alternatively, the instruction may identify a specific switching pattern for the antennas of the first wireless device's antenna array, where implementation of the specific switching pattern will result in the antenna array collectively forming a beam that is steered in the direction determined in block 206.

The method 200 ends in block 210.

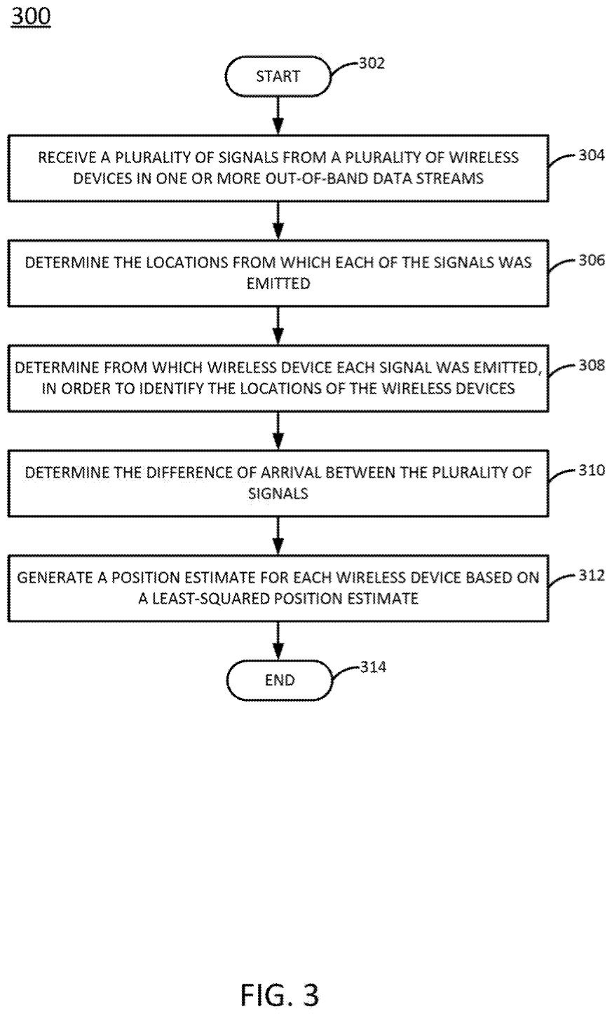

FIG. 3 is a flow diagram illustrating an example method 300 for determining the locations of a plurality of wireless client devices operating simultaneously in the same wireless network. The method 300 may be performed by the beam steering apparatus 114 of FIG. 1. As such, reference may be made in the discussion of the method 300 to various components of the wireless network 100. Such references are made for the sake of example, however, and do not limit the means by which the method 300 may be implemented.

The method 300 begins in block 302. In block 304, a plurality of signals s₁-s_{M} are received from a plurality of wireless devices in one or more out-of-band data streams. In this case, out-of-band refers to the fact that the data streams are not carried over the data channels that are used to exchange application data between the plurality of wireless devices (where data streams that are carried over these data channels would be in-band data streams). Each of the signals s₁-s_{M} may be emitted by a different wireless client device, such as a different HMD. In one example, a signal emitted by a wireless device i may be represented as:

$${s}_{i} ( n ) = {\sum }_{k = 1}^{p} ϕ ( {θ}_{k} , n ) ; {s}_{i}^{T} {s}_{j} = \{ \begin{matrix}1 ; & i = j \\ 0 ; & i \neq j\end{matrix} \qquad ( EQN . 1 )$$

where n denotes the sample time, i denotes to the i^{th} wireless client device from which the signals are received, p denotes the number of basis functions φ (e.g., where φ may be a complex exponential, a sinusoid, or the like), and θ denotes the parameters describing each basis function (e.g., where there could be k number of parameters describing the basis functions).

In block 306, the location from which each signal was emitted is determined. In one example, the coordinates from which a signal i was emitted may be expressed as (xᵢ, yᵢ, zᵢ): rᵢ.

In block 308, it is determined from which wireless device each signal was emitted. In one example, block 308 involves signal extraction and/or enhancement, which may further involve phase estimation. In one example, ∀ᵢ; sᵢ^{T}r_{1,2, . . . ,n}. Thus, the locations of each of the wireless devices may be determined by associating each wireless device with one of the signals whose location of emission was determined in block 306.

In block 310, the time difference of arrival between the signals emitted by the wireless devices is determined. In one example sᵢ(n),∀ᵢ.

In block 312, a position estimate is generated for each wireless client device based on a least-squared position estimate.

The method 300 ends on block 314.

It should be noted that although not explicitly specified, some of the blocks, functions, or operations of the methods 200 and 300 described above may include storing, displaying and/or outputting for a particular application. In other words, any data, records, fields, and/or intermediate results discussed in the method can be stored, displayed, and/or outputted to another device depending on the particular application. Furthermore, blocks, functions, or operations in FIGS. 2 and 3 that recite a determining operation, or involve a decision, do not necessarily imply that both branches of the determining operation are practiced.

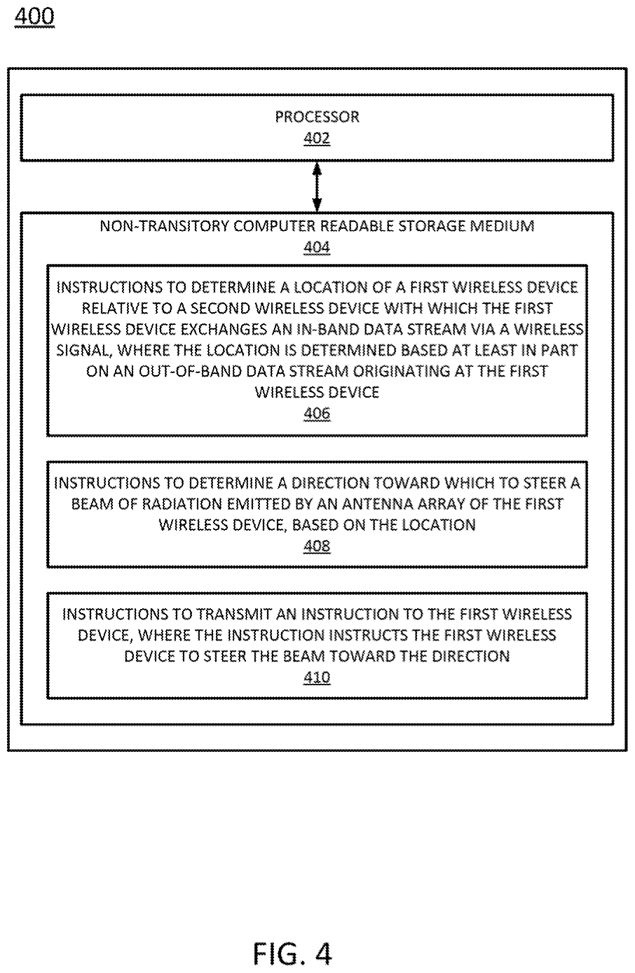

FIG. 4 illustrates an example of an apparatus 400. In one example, the apparatus 400 may be the beam steering apparatus 114 of FIG. 1. In one example, the apparatus 400 may include a processor 402 and a non-transitory computer readable storage medium 404. The non-transitory computer readable storage medium 404 may include instructions 406, 408, and 410 that, when executed by the processor 402, cause the processor 402 to perform various functions.

The instructions 406 may include instructions to determine a location of a first wireless device relative to a second wireless device with which the first wireless device exchanges an in-band data stream via a wireless signal. In one example, the location is determined based at least in part on an out-of-band data stream originating at the first wireless device. The instructions 408 may include instructions to determine a direction toward which to steer a beam of radiation emitted by an antenna array of the first wireless device, based on the location. The instructions 410 may include instructions to transmit an instruction to the first wireless device. In one example, the instruction instructs the first wireless device to steer the beam toward the direction.

It will be appreciated that variants of the above-disclosed and other features and functions, or alternatives thereof, may be combined into many other different systems or applications. Various presently unforeseen or unanticipated alternatives, modifications, or variations therein may be subsequently made which are also intended to be encompassed by the following claims.

What is claimed is:

1. An apparatus, comprising:
a sensor to detect a first out-of-band data stream originating at a first wireless device that exchanges an in-band data stream with a second wireless device via a wireless signal; and
a processor to determine a location of the first wireless device based on the first out-of-band data stream and to transmit an instruction to the first wireless device to steer a beam emitted by an antenna array of the first wireless device so that a strength of the wireless signal is increased.

2. The apparatus of claim 1, wherein the sensor is an audio sensor.

3. The apparatus of claim 1, wherein the sensor is a three-dimensional depth sensor.

4. The apparatus of claim 1, wherein the sensor is an energy sensor.

5. The apparatus of claim 1, wherein the first wireless device is a wireless access point, and the second wireless device is a wireless client device.

6. The apparatus of claim 1, wherein the first wireless device is a wireless client device, and the second wireless device is a wireless access point.

7. A method, comprising:
determining a location of a first wireless device relative to a second wireless device with which the first wireless device exchanges an in-band data stream via a wireless signal, wherein the location is determined based at least in part on an out-of-band data stream originating at the first wireless device;
determining a direction toward which to steer a beam of radiation emitted by an antenna array of the first wireless device, based on the location; and
transmitting an instruction to the first wireless device, wherein the instruction instructs the first wireless device to steer the beam toward the direction.

8. The method of claim 7, wherein the out-of-band data stream comprises an audio beacon emitted by the first wireless device.

9. The method of claim 7, wherein the out-of-band data stream comprises an imaging sensor feed that tracks movement of the first wireless device.

10. The method of claim 7, wherein the out-of-band data stream comprises a pattern of infrared signals emitted by the first wireless device.

12. The method of claim 7, wherein the out-of-band data stream comprises energy emitted by the first wireless device.

13. The method of claim 7, wherein the determining comprises:
identifying a plurality of weights associated with a plurality of antennas of the antenna array, wherein the plurality of weights is predetermined to provide an optimal strength of the wireless signal based on the location.

14. A non-transitory machine-readable storage medium encoded with instructions executable by a processor, the machine-readable storage medium comprising:
instructions to determine a location of a first wireless device relative to a second wireless device with which the first wireless device exchanges an in-band data stream via a wireless signal, wherein the location is determined based at least in part on an out-of-band data stream originating at the first wireless device;
instructions to determine a direction toward which to steer a beam of radiation emitted by an antenna array of the first wireless device, based on the location; and
instructions to transmit an instruction to the first wireless device, wherein the instruction instructs the first wireless device to steer the beam toward the direction.

15. The non-transitory machine-readable storage medium of claim 14, wherein the instructions to determine comprise:
instructions to identify a plurality of weights associated with a plurality of antennas of the antenna array, wherein the plurality of weights is predetermined to provide an optimal strength of the wireless signal based on the location.
